(19) United States
(12) Patent Application Publication
(10) Pub. No.: US 2004/0045591 A1
(43) Pub. Date: Mar. 11, 2004

(54) Automatic cleaning tool for the interior of NC machines

(76) Inventor: Karl Bauch, Kempten (DE)

Correspondence Address: Woodard, Emhardt, Naughton,, Moriarty and McNett LLP, Bank One Center/Tower, 111 Monument Circle, Suite 3700, Indianapolis, IN, 46204-5137, US

(21) Appl. No.: 10/386,227

(22) Filed: Mar. 11, 2003

(30) Foreign Application Priority Data
Sep. 9, 2002 (DE) 20213956.5

(51) Int. Cl. B08B 3/00

(52) U.S. Cl. 134/56 R; 134/172; 134/198; 239/390; 239/436

(57) ABSTRACT

Automatic cleaning tool (3) for interior cleaning of numerically controlled machine tools for automatic insertion into the spindle or tool-holding fixtures (1), for cleaning by means of spindle movement with supply of a fluid.

Modern metal-cutting machines are being encapsulated more and more, that is, housed in such a way that there is the least possible emission of noise, pollution and other harmful substances. Following the manufacturing process the workpieces are cleaned by the machine operator, or are channeled through cleaning plants. In rare cases this cleaning is taken over by tools which are changed in the machine spindle. Such tools are seen in the prospectus and catalog put out by the company Lang. These tools marketed by Lang are self-pivoting rotors providing air whirl. Cleaning the machine interiors with all their corners and different shaped spaces is simply not possible using this tool, or offers an unsatisfactory and uneconomical solution. With the rotor blade solution chips are whirled around and are not systematically transported out. Solutions for internal cleaning, in particular in series machines, are offered by bed rinsing and surge showers. These units are not only expensive due to the considerable quantities of fluid required and the necessary pumps, containers and filters, but also require a considerable amount of space. Surge showers and bed rinsing cannot be installed at every point on the machine. And because of their fixed arrangement they cannot be adjusted to varying conditions, such as tools, machine tools and the like, or can, but only with difficulty.

To date, for these reasons the machine operator has had to regularly clean machines by hand. The problem here is that cooling lubricants employed for cleaning contain a large number of chemicals which are particularly unpleasant and dangerous for the operator, both individually and especially in combination. In the event of skin contact the majority of machine operators complains about allergic reactions and skin conditions. Aerosols released when the machine is opened are also substantially health-threatening. The extreme pressure placed on the operator during manual cleaning caused by dirt, bacteria-laden, stinking cooling lubricants and the like must therefore no longer be emphasized.

The object of the invention is to provide a cleaning method or a tool suitable therefor which permits automatic self-cleaning of the internal area of the machine and takes this responsibility away from the operator, without requiring unreasonably high investments. It is of special note that this tool be suited to different machines with varying dimensions, housing shapes and contamination properties. Also essential is that the movement sequences and positions of the cleaning tool adapt to different media, media pressures and media flow rates.

This task is solved according to the present invention, as described in claim 1. Further developments and special configurations are described in the sub-claims. The automatic cleaning tool for machine interiors cleans by way of the medium supplied on the machine side, especially by the machine tool spindle, and by way of the spindle motion. During spindle motion both position and speed can be programmed in the individual axes, as well as rotation of the tool itself. In this way different shaped spaces can be freed of chips and contamination extremely flexibly and practically without limits. A spherical tool body, preferably ball-shaped, has recesses, preferably in the form of bores, which function directly as a nozzle or for housing nozzles or seals. The bores can be arranged over the entire ball surface, with the exception of the area for fluid supply, at any angle. In this way it is possible to cover a cleaning area over 360° with respect to the axis of rotation. In a particular configuration the cleaning tool comprises various geometric bodies, each with recesses or nozzles placed almost vertically to the surface. The nozzles or bores can be sealed off individually or replaced by nozzles of lesser cross-section, so that adaptation to different fluids, fluid pressures, fluid flows and cleaning areas is guaranteed. The interior of the tool is preferably equipped such that the whole tool has the same wall thickness. Alternatively, the inner contour can also take on other shapes, for example cylindrical recesses such as bores.

As a further development of this tools it is provided with intermediate channels, which convey the fluid from the central supply to one or more nozzles. These channels can be sealed or opened by machine by means of sealing bodies, preferably balls, in the tool on account of their specific orientation, position of rotation or acceleration. If a sealing body, e.g. a rubber ball, is located because of gravity on the crossing or opening point from the supply channel to the intermediate channel and if cleaning medium is then supplied under pressure, then the sealing body is pressed hydraulically against the opening of the intermediate channel and seals this and subsequent nozzles. The sealing or switching position of the sealing body then remains intact during rotation or acceleration. This design makes it possible to align the tool automatically to different cleaning areas or to account for varying quantities of throughflow. However many sealing bodies a tool contains, which diameter or dimensional graduation these have or however many switching possibilities they have, is left up to client requisites and structural variants. Through positioning one or more switching elements before the supply profile of one or more nozzles or bores can the fluid flow be controlled such that only a percentage of the nozzles is supplied with fluid. Due to the inner fluid pressure the circuit element is pressed against the outwardly unpressurized opening and seals the former throughout the entire process, or as long as the cleaning fluid flows without interruption. This switching method enables a tool, which is configured in normal position for all-round cleaning, to be programmed automatically to clean only the back space or the front space.

To automatically switch the tool for different cleaning areas there is at least one circuit element, for example in the form of a steel ball inside the cleaning tool, which is pressed into a channel opening or also a park position, depending on orientation or acceleration during fluid supply. Due to the positioning of one or more circuit elements in front of the supply cross-sections of one or more nozzles or bores the fluid flow can be controlled such that only a percentage of the nozzles is supplied with fluid. Due to the inner fluid pressure the circuit element is pressed against the outwardly unpressurized opening and seals the former throughout the entire process, or as long as the cleaning fluid flows without interruption. This switching method enables a tool, which is configured in normal position for all-round cleaning, to be programmed automatically to clean only the back space or the front space.

Due to the configuration of the tool as a centrifugal disc or as a spinner rotation can be employed for additional introduction of energy into the cleaning medium. With respect to construction of the tools there is a detachable gate of the cleaning tool on holders for the machine tool spindle. This allows the interior of the cleaning tool to be better processed. When the tool is made of one structural component greater binding or a sealing element on the tool would be necessary.

In the following figures

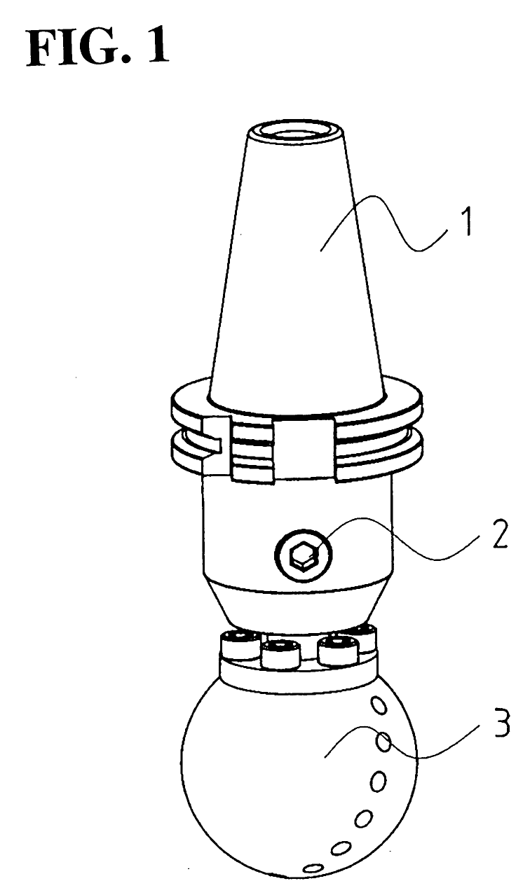

FIG. 1 shows a spherical cleaning tool with quick-release taper holder,

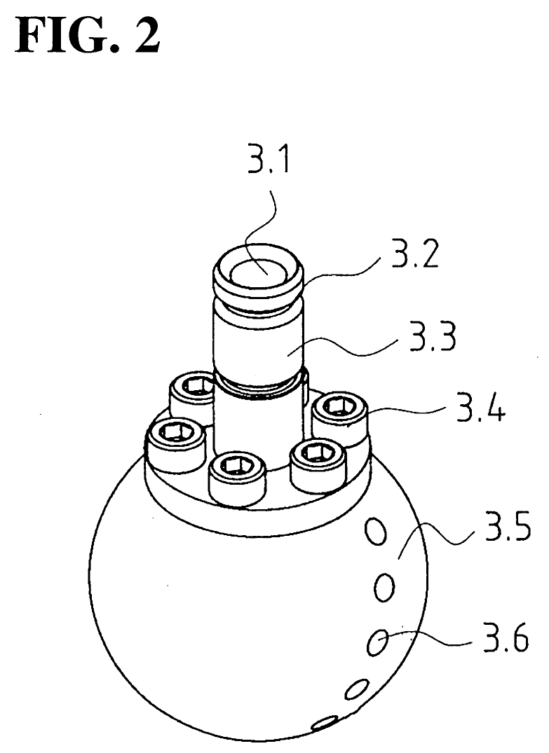

FIG. 2 shows a spherical cleaning tool without holder,

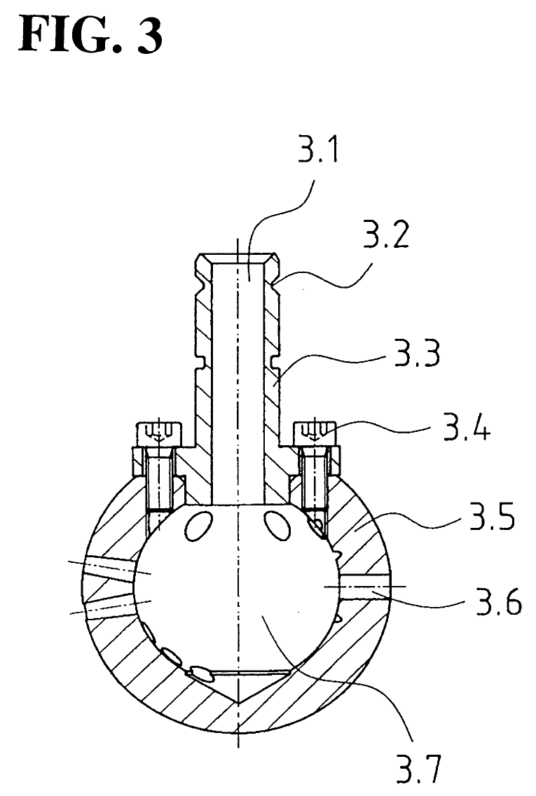

FIG. 3 shows a section through FIG. 2,

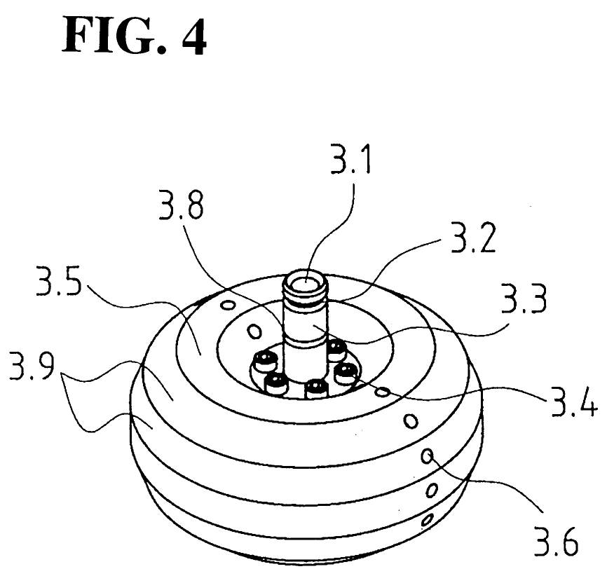

FIG. 4 shows a cleaning tool with tapered faces arranged at an angle to one another,

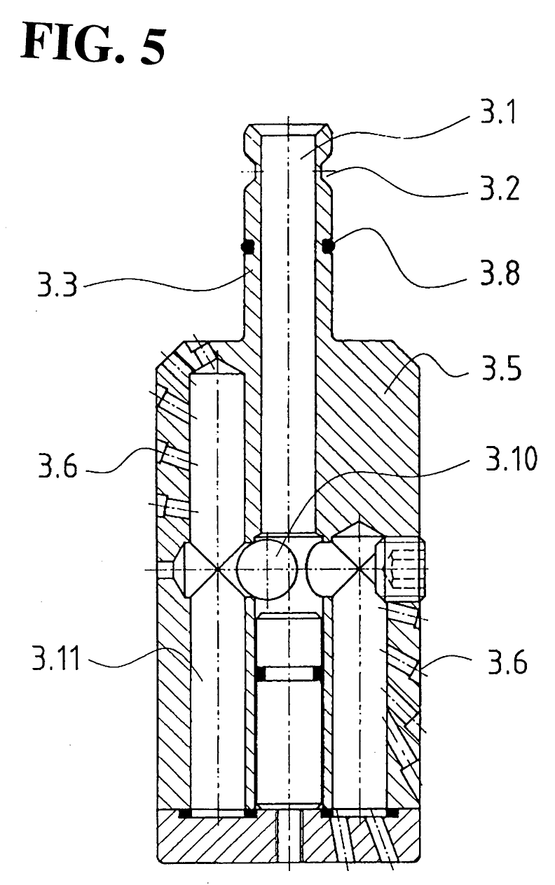

FIG. 5 shows a cleaning tool with switch mechanism.

The function of the tool with its further developments can be described with reference to the diagrams as follows:

With insertion of the cleaning tool into the holder (1) or the spindle connection is made with the fluid supply channel of the machine spindle. The tool can be set in rotation by the machine spindle and can move freely in the machine space, corresponding to machine capabilities. The supplied fluid is subdivided into several streams, depending on configuration of the tool. The radiation angles can be set, depending on which nozzle is opened or closed. When the tool is designed with the largest possible diameter and is rotated fast, the fluid also accelerates, resulting in higher impact speed and thus an improved cleaning effect. In a further development of the tool only one stream is effused by the tool. This alternates at a preset angle. This stream is not necessarily a round stream, but can be configured as a flat stream or as a stream of another geometric form.

FIG. 1 illustrates a cleaning tool (3) and a threaded fastening pin (2) acting as a connector. The cleaning tool (3) is shown with a spherical surface, which has a radiation angle of ca. 270°. The tool body (3.5) is attached to the fixture extension (3.1) by means of connecting elements (3.4). The fluid flows from the tool-holding fixture or from the machine spindle through the supply channel (3.1) into the cavity (3.7), where it spreads out under the same pressure. The nozzles set in the discharge openings (3.6) can be sealed off individually. The sealing groove (3.8) acts to accommodate a sealing ring and seal between cleaning tool (3) and holder (1). The fluid flows out of the nozzles and, depending on angle of rotation or velocity, is radiated over a clearly defined area of the machine housing or the entire machine housing.

FIG. 2 illustrates the same tool in a semi-section, though without the inset connecting elements and without the sealing elements between tool body (3.5) and tool extension (3.3), as well as without sealing on the tool extension (3.3) for sealing against the tool-holding fixture. The discharge opening (3.6) in the tool body (3.5) has a conical path to achieve optimal possible flow conditions or an optimal cleaning effect. Alternatively, these recesses are designed cylindrical for inserting inserts, or are provided with threads for inserting nozzles. Other geometric shapes for the recesses, such as e.g. slots, slits etc., are not illustrated. The discharge openings (3.6) are arranged on one side of the tool body (3.5) linear to the axis of rotation and in spiral orientation on the other side.

FIG. 4 illustrates further to FIG. 1 a tool with a series of tapered and/or cylindrical faces. Set into these faces at right angles are recesses, preferably bores, which make the connections with the cavity (3.7). This tool also has the capability of radiating a tool-holding fixture and thus reaching a radiation area of 360°. The bore can be arranged, as shown in FIG. 3, in a straight shorn edge through the body, or it can be spiral.

FIG. 5 illustrates a cleaning tool whose fixture extension is attached firmly to the tool body. Supply channels in the tool having at least one transverse bore allow a sealing body, preferably a ball, depending on the orientation of the tool at the time of fluid supply, to supply only a specific portion of the recesses with fluid. The cavity is sealed by means of a lid which can also be provided with bores for releasing the fluid.

Alternatively, several sealing bodies are arranged in the cavity in such a way that they seal off various radiating recesses depending on orientation. Due to pressurizing and the resulting difference in pressure between tool interior and surrounds, and on account of the unloaded recess surface the sealing body remains on the recess which it has sealed during pressurizing.

Legend:

1 holder

2 threaded fastening pin

3 cleaning tool

3.1 supply channel

3.2 stop groove

3.3 extension

3.4 connecting element

3.5 tool body

3.6 discharge opening

3.7 cavity

3.8 sealing groove

3.9 tapered faces

3.10 sealing element

3.11 intermediate channel

1. An automatic cleaning tool (3) for automatic cleaning, in particular interior cleaning by means of fluid for numerically controlled machine tools, characterized in that the extension (3.3) formed to attach has at least one through channel (3.1) which terminates in the interior (3.7) of the preferably spherical tool body (3.5) provided with at least one discharge opening (3.6).

2. The cleaning tool (3) for interior cleaning for automatic cleaning, in particular interior cleaning by means of fluid for numerically controlled machine tools as claimed in claim 1, characterized in that the tool body (3.5) has a series of faces and discharge openings (3.6) arranged vertically to these faces at various angles to the axis of rotation.

3. The cleaning tool (3) for interior cleaning for automatic cleaning, in particular interior cleaning by means of fluid for numerically controlled machine tools as claimed in claim 1, characterized in that the tool body (3.5) comprises a number of tapered faces (3.9) at various angles, in which discharge openings (3.6) are arranged.

4. The cleaning tool (3) for interior cleaning for automatic cleaning, in particular interior cleaning by means of fluid for numerically controlled machine tools as claimed in at least one of claims 1 to 3, characterized in that the openings of the tool body are sealable nozzles.

5. The cleaning tool (3) for interior cleaning for automatic cleaning, in particular interior cleaning by means of fluid for numerically controlled machine tools as claimed in at least one of claims 1 to 4, characterized in that the discharge openings (3.6) of the tool body (3.5) are bores, slots and/or other recesses with cross-sections advantageous in fluid technics terms.

6. The cleaning tool (3) for interior cleaning for automatic cleaning, in particular interior cleaning by means of fluid for numerically controlled machine tools as claimed in at least one of claims 1 to 3, characterized in that the discharge openings (3.6) in the tool body (3.5) are provided with threads and/or have a funnel shape.

7. The cleaning tool (3) for interior cleaning for automatic cleaning, in particular interior cleaning by means of fluid for numerically controlled machine tools as claimed in at least one of claims 1 to 6, characterized in that the tool (3) has at least one switching sealing element (3.10), preferably a ball, which closes or opens individual intermediate channels and discharge openings (3.6) in the tool body (3.5) between supply channel (3.1) and intermediate channel (3.11).

8. The cleaning tool (3) for interior cleaning for automatic cleaning, in particular interior cleaning by means of fluid for numerically controlled machine tools as claimed in at least one of claims 1 to 7, characterized in that the tool body (3.5) is composed of several segments.

9. The cleaning tool (3) for interior cleaning for automatic cleaning, in particular interior cleaning by means of fluid for numerically controlled machine tools as claimed in at least one of claims 1 to 8, characterized in that at least one pressure control valve is integrated to secure against overload and bursting.

10. The cleaning tool (3) for interior cleaning for automatic cleaning, in particular interior cleaning by means of fluid for numerically controlled machine tools as claimed in claims 1 to 9, characterized in that the discharge opening (3.6) is arranged on the tool body (3.5) in a line and/or in a spiral to the axis of rotation.
